(19) United States
(12) Patent Application Publication
(10) Pub. No.: US 2022/0258767 A1
(43) Pub. Date: Aug. 18, 2022

(54) SYSTEM AND METHOD FOR CONTROLLING AUTONOMOUS MOBILITY

(71) Applicants: HYUNDAI MOTOR COMPANY, Seoul (KR); KIA CORPORATION, Seoul (CN)

(72) Inventors: Eun Young Choi, Seoul (KR); Jin Su Jeong, Suwon-si (KR); Woo Jin Kim, Incheon (KR); Seo Hyung Cheon, Seongnam-si (KR); Rosali Sun Pyun, Seongnam-si (KR); Ki Seok Seong, Cheonan-si (KR); Don Il Yang, Seoul (KR); Min Sang Yu, Hwaseong-si (KR)

(73) Assignees: HYUNDAI MOTOR COMPANY, Seoul (KR); KIA CORPORATION, Seoul (KR)

(21) Appl. No.: 17/410,397

(22) Filed: Aug. 24, 2021

(30) Foreign Application Priority Data
Feb. 17, 2021 (KR) 10-2021-0021386

(51) Int. Cl. B60W 60/00; G06Q 10/02; G06Q 50/30; G06F 21/32; G06K 9/00

(52) U.S. Cl. CPC B60W 60/0016; B60W 60/00253; G06Q 10/02; G06K 9/00369; G06F 21/32; G06K 9/00838; G06Q 50/30

(57) ABSTRACT

A system for controlling an autonomous mobility is provided. The system includes a portable device that inputs and transmits boarding reservation information of a passenger under a preset age, and the autonomous mobility that senses a passenger, activates a passenger protect mode and travel to a destination when the sensed passenger matches the boarding reservation information, determines whether a guardian of the passenger has arrived at the destination after arriving at the destination, and determines whether to allow the passenger to alight based on a determination result.

### CROSS-REFERENCE TO RELATED APPLICATION

This application claims the priority to and the benefit of Korean Patent Application No. 10-2021-0021386, filed on Feb. 17, 2021, the entire contents of which are incorporated herein by reference.

### TECHNICAL FIELD

The present disclosure relates to a system and a method for controlling an autonomous mobility.

### BACKGROUND

In recent years, a development of an autonomous mobility technology such as a robotaxi, a robo shuttle, and the like that transport a passenger to a destination using an autonomous vehicle has been in progress.

The robotaxi may transport the passenger from a place where a call is made to a desired destination only by autonomous driving without a separate driver's seat and a driver. The robo shuttle may create a travel route in consideration of boarding points of a plurality of passengers with the same destination, and transport the plurality of passengers to the destination based on the created travel route.

A technology capable of transporting the passenger to the destination more safely must be secured to spread such autonomous mobility. In particular, a technology that, even when a situation in which a child boards the robotaxi alone occurs, enables the child to safely travel to the destination after boarding the robotaxi alone may be desirable.

### SUMMARY

An aspect of the present disclosure provides a system and a method for controlling an autonomous mobility that perform control such that a child passenger may safely travel to a destination even when the child needs to board alone the autonomous mobility to reach the destination.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a system for controlling an autonomous mobility includes a portable device that inputs and transmits boarding reservation information of a passenger under a preset age, and the autonomous mobility that senses a passenger, activates a passenger protect mode and travel to a destination, when the sensed passenger and the boarding reservation information match with each other, determines whether a guardian of the passenger has arrived at the destination after arriving at the destination, and determines whether to allow the passenger to alight based on the determination result.

In one implementation, the boarding reservation information may include one or more of information on a person who made a reservation, passenger information, destination information, and information on the guardian of the passenger.

In one implementation, the portable device may transmit a travel request signal of the autonomous mobility generated by an input of the person who made the reservation.

In one implementation, the autonomous mobility may sense the passenger based on one or more of an image of the passenger, a weight of the passenger, and authentication information of the passenger.

In one implementation, the autonomous mobility may guide the passenger to alight when the sensed passenger and the boarding reservation information do not match with each other.

In one implementation, the autonomous mobility may start recording acquired audio and image after the passenger is sensed, output a video for a child, and control to maintain a state capable of communicating the person who made the reservation when the passenger protect mode is activated.

In one implementation, the autonomous mobility may determine whether an accessor is sensed at the destination based on surrounding environment information after arriving at the destination.

In one implementation, the autonomous mobility may acquire one or more of an image, an authentication code, and a fingerprint of the accessor when the accessor is sensed, and compare the acquired information with the boarding reservation information to determine whether the accessor is the guardian of the passenger.

In one implementation, the autonomous mobility may control a door to maintain a locked state when it is determined that the accessor is not sensed at the destination.

In one implementation, the autonomous mobility may include a robotaxi.

According to another aspect of the present disclosure, a method for controlling an autonomous mobility includes transmitting boarding reservation information to the autonomous mobility when the boarding reservation information of a passenger under a preset age is input to a portable device, sensing, by the autonomous mobility, a passenger, activating a passenger protect mode and travelling to a destination when the sensed passenger and the boarding reservation information match with each other, and determining whether a guardian of the passenger has arrived at the destination after arriving at the destination, and determining whether to allow the passenger to alight based on the determination result.

In one implementation, the boarding reservation information may include one or more of information on a person who made a reservation, passenger information, destination information, and information on the guardian of the passenger.

In one implementation, the method may further include transmitting, to the autonomous mobility, a travel request signal of the autonomous mobility generated by the portable device by an input of the person who made the reservation.

In one implementation, the sensing, by the autonomous mobility, of the passenger may include sensing, by the autonomous mobility, the passenger based on one or more of an image of the passenger, a weight of the passenger, and authentication information of the passenger.

In one implementation, the method may further include guiding the passenger to alight when the sensed passenger and the boarding reservation information do not match with each other.

In one implementation, the activating of the passenger protect mode and travelling to the destination may include starting, by the autonomous mobility, recording acquired audio and image after the passenger is sensed, outputting a video for a child, and controlling to maintain a state capable of communicating the person who made the reservation.

In one implementation, the method may further include determining whether an accessor is sensed at the destination based on surrounding environment information after arriving at the destination.

In one implementation, the method may further include acquiring one or more of an image, an authentication code, and a fingerprint of the accessor when the accessor is sensed, and comparing the acquired information with the boarding reservation information to determine whether the accessor is the guardian of the passenger.

In one implementation, the method may further include controlling a door to maintain a locked state when it is determined that the accessor is not sensed at the destination.

In one implementation, the autonomous mobility may include a robotaxi.

### DRAWINGS

The above and other objects, features and advantages of the present disclosure will be more apparent from the following detailed description taken in conjunction with the accompanying drawings:

FIG. 1 is a diagram illustrating a configuration of an autonomous mobility control system in one form of the present disclosure;

FIG. 2 is a diagram illustrating a configuration of a portable device in one form of the present disclosure;

FIG. 3 is a diagram illustrating a configuration of an autonomous mobility in one form cf the present disclosure;

FIG. 4 is a diagram illustrating an autonomous mobility control method in one form of the present disclosure; and

FIG. 5 illustrates a configuration of a computing system in which a method in one form of the present disclosure is implemented.

### DETAILED DESCRIPTION

Hereinafter, some forms of the present disclosure will be described in detail with reference to the exemplary drawings. In adding the reference numerals to the components of each drawing, it should be noted that the identical or equivalent component is designated by the identical numeral even when they are displayed on other drawings. Further, in describing some forms of the present disclosure, a detailed description of the related known configuration or function will be omitted when it is determined that it interferes with the understanding of the form of the present disclosure.

In describing some forms of the present disclosure, terms such as first, second, A, B, (a), (b). and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

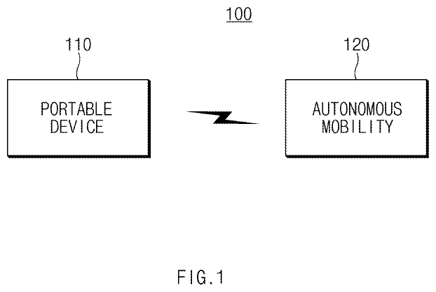

FIG. 1 is a diagram illustrating a configuration of an autonomous mobility control system in some forms of the present disclosure.

An autonomous mobility control system 100 in some forms of the present disclosure in FIG. 1 may include a portable device 110 and an autonomous mobility 120.

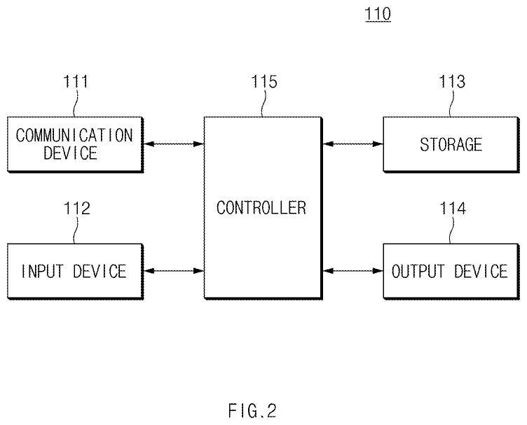

The portable device 110 may receive boarding reservation information of a passenger by a person who made a reservation, and transmit the input boarding reservation information to the autonomous mobility 120. In some forms of the present disclosure, the portable device 110 may receive boarding reservation information of a passenger under a preset age. In this case, the boarding reservation information may include information on the person who made the reservation, passenger information, destination information, and information on a guardian of the passenger. In this connection, the passenger under the preset age may include a child or a minor. The portable device 110 may transmit a travel request signal of the autonomous mobility generated by an input of the person who made the reservation. FIG. 2 will be referred to for a more detailed description of the portable device 110.

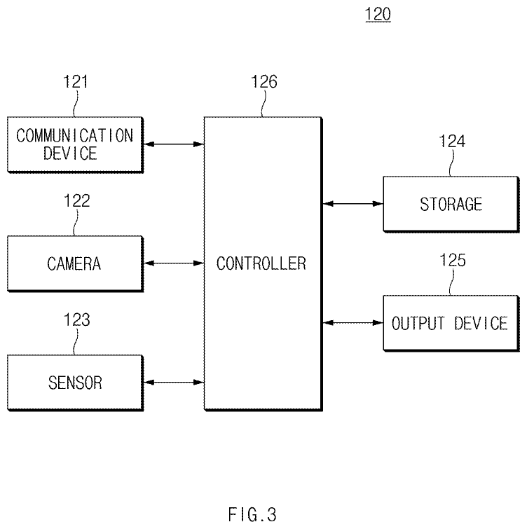

The autonomous mobility 120 may sense the passenger, activate a passenger protect mode and travel to a destination when the sensed passenger and the boarding reservation information (the passenger information) received from the portable device 110 match with each other, determine whether the guardian of the passenger has arrived at the destination after arriving at the destination, and determine whether to allow the passenger to alight based on the determination result. In sane forms of the present disclosure, when it is determined that the guardian of the passenger has arrived at the destination after arriving at the destination, the autonomous mobility 120 may guide the passenger to alight and control a door to be opened. On the other hand, when it is determined that the guardian of the passenger has not arrived at the destination after arriving at the destination, the autonomous mobility 120 may control the door to maintain a locked state. FIG. 3 will be referred to for a more detailed description of the autonomous mobility 120.

FIG. 2 is a diagram illustrating a configuration of a portable device in some forms of the present disclosure.

As shown in FIG. 2, the portable device 110 may include a communication device 111, an input device 112, storage 113, an output device 114, and a controller 115.

The communication device 111 may perform a wireless communication with the autonomous mobility 120. For example, the communication device 111 may communicate with the autonomous mobility 120 in various wireless communication schemes such as a Wi-Fi, a WiBro, a global system for mobile communication (GSM), a code division multiple access (CDMA), a wideband code division multiple access (WCDMA), an universal mobile telecommunication system (UMTS), a time division multiple access (TDMA), a long term evolution (LTE), and the like.

The input device 112 may receive an input signal corresponding to a manipulation, an operation, or a voice of the person who made the reservation, and the controller 115 may generate boarding reservation information corresponding to the input signal.

The storage 113 may store at least one algorithm that performs an operation or an execution of various commands for an operation of the portable device in some forms of the present disclosure. The storage 113 may include at least one of storage media of a flash memory, a hard disc, a memory card, a read-only memory (ROM), a random access memory (RAM), an electrically erasable programmable read-only memory (EEPROM), a programmable read-only memory (PROM), a magnetic memory, a magnetic disk, and an optical disk.

The output device 114 may visually or audibly provide a function assigned to the input device 112. The output device 114 may be implemented as a display device, a sound output device, or the like.

The controller 115 may be implemented by various processing devices such as a microprocessor or the like with an embedded semiconductor chip or the like capable of performing the operation or the execution of the various commands, and may control the operation of the portable device in sane forms of the present disclosure.

The controller 115 may perform an output through the output device 114 such that the person who makes the reservation inputs the boarding reservation information. In some forms of the present disclosure, the controller 115 may store a separate application into which the boarding reservation information may be input, and output the application through the output device 114.

As an example, the controller 115 may select a minor boarding mode when the passenger under the preset age is included in the boarding reservation information, and may output a guide message such that the boarding reservation information is input. In some forms of the present disclosure, the controller 115 may output the guide message such that the information on the person who made the reservation, the passenger information, the destination information, and the information on the guardian of the passenger are input as the boarding reservation information.

When the minor boarding mode is selected and the boarding reservation information is input, the controller 115 may transmit the boarding reservation information to the autonomous mobility. In addition, when the door closing signal is received after receiving information indicating that the passenger matching the boarding reservation information (the passenger information) is sensed from the autonomous mobility, the controller 115 may transmit the travel request signal of the autonomous mobility generated by the input of the person who made the reservation.

FIG. 3 is a diagram illustrating a configuration of an autonomous mobility in some forms of the present disclosure.

As shown in FIG. 3, the autonomous mobility 120 may include a communication device 121, a camera 122, a sensor 123, storage 124, an output device 125, and a controller 126.

The communication device 121 may perform a wireless communication with the portable device 110. For example, the communication device 121 may communicate with the portable device 110 in the various wireless communication schemes such as the Wi-Fi, the WiBro, the global system for mobile communication (GSM), the code division multiple access (CDMA), the wideband code division multiple access (WCDMA), the universal mobile telecommunication system (UMTS), the time division multiple access (TDMA), the long term evolution (LTE), and the like.

The camera 122 may include cameras that shot images of a region in a travel direction and a surrounding region and are arranged at front, rear, left, and right sides of the autonomous mobility, and an internal camera that acquires an image of the passenger.

The sensor 123 may sense one or more of autonomous mobility state information, the passenger information, and information on surroundings of the autonomous mobility. In some forms of the present disclosure, the sensor 123 may sense closing or opening of the autonomous mobility door, and sense a weight of the passenger and authentication information (e.g., a QR code) of the passenger. As an example, the sensor 123 may include a door sensor, a passenger weight sensor disposed on a seat, an image sensor, and the like.

The storage 124 may store at least one algorithm that performs an operation or an execution of various commands for an operation of the autonomous mobility in some forms of the present disclosure. The storage 124 may include at least one of the storage media of the flash memory, the hard disc, the memory card, the read-only memory (ROM), the random access memory (RAM), the electrically erasable programmable read-only memory (EEPROM), the programmable read-only memory (PROM), the magnetic memory, the magnetic disk, and the optical disk.

The output device 125 may output an image or sound under control of the controller 126. In some forms of the present disclosure, the output device 125 may be implemented as a display device, a sound output device, or the like. In this connection, the display device may include a display of a navigation device, a HUD, a cluster, and the like.

The controller 126 may be implemented by various processing devices such as the microprocessor or the like with the embedded semiconductor chip or the like capable of performing the operation or the execution of the various commands, and may control the operation of the autonomous mobility in some forms of the present disclosure.

The controller 126 may receive the boarding reservation information from the portable device 110. In some forms of the present disclosure, the controller 126 may receive the boarding reservation information of the passenger under the preset age.

When sensing the door opening after receiving the boarding reservation information, the controller 126 may transmit a door opening signal to the portable device 110.

When sensing the door opening, the controller 126 may determine that the passenger is on board and sense the passenger. In some forms of the present disclosure, the controller 126 may sense the passenger based on one or more of the image of the passenger, the weight of the passenger, and the authentication information of the passenger using the camera 122 and the sensor 123. In addition, when the passenger is sensed, the controller 126 may transmit sensed passenger information to the portable device 110.

The controller 126 may determine whether the sensed passenger and the passenger information included in the boarding reservation information match with each other. In some forms of the present disclosure, because the boarding reservation information received by the controller 126 includes the information of the passenger under the preset age, the operation of determining whether the sensed passenger and the passenger information included in the boarding reservation information match with each other is preferably understood as an operation of determining whether the sensed passenger is the passenger under the preset age (e.g., the child).

When the sensed passenger and the passenger information included in the boarding reservation information match with each other, that is, when it is determined that, the sensed passenger is the passenger under the preset age, the controller 126 may sense the door closing. When sensing the door closing, the controller 126 may transmit the door closing signal to the portable device 110. On the other hand, when it is determined that the sensed passenger and the passenger information included in the boarding reservation information do not match with each other, that is, when it is determined that, the sensed passenger is not the passenger under the preset age, the controller 126 may control to guide the passenger to alight. In some forms of the present disclosure, the controller 126 may unlock the door to allow the passenger to alight.

When the travel request signal is received from the portable device 110 after the door closing signal is transmitted to the portable device 110, the controller 126 may control to start travel. In this connection, the controller 126 may allow the autonomous mobility to travel to the destination by activating the passenger protect mode while starting the travel. In sane forms of the present disclosure, when the passenger protect mode is activated, the controller 126 may start recording acquired audio and image after the passenger is sensed, output a video for the child, and control to maintain a state in which a communication with the person who made the reservation is possible. In addition, when the passenger protect mode is activated, even when there is an input of the passenger inside the autonomous mobility, the controller 126 may determine the input as a wrong manipulation and deactivate a function based on the input of the passenger. That is, when the travel of the autonomous mobility starts, the controller 126 may monitor the passenger of the autonomous mobility in real time, and may perform an operation capable of protecting the passenger.

When it is determined that the passenger has arrived at the destination, the controller 126 may determine whether an accessor accessing the autonomous mobility is sensed at the destination. In some forms of the present disclosure, the controller 126 may determine whether the accessor is sensed based on the image of the surrounding region acquired by the camera 122.

When it is determined that the accessor is sensed at the destination, the controller 126 may compare the sensed accessor with the boarding reservation information (the information on the guardian of the passenger) to determine whether the accessor is the guardian of the passenger. In some forms of the present disclosure, the controller 126 may acquire one or more of an image of the accessor, an authentication code of the accessor, and a fingerprint. In addition, the controller 126 may determine whether the sensed accessor is the guardian of the passenger included in the boarding reservation information based on the acquired information.

On the other hand, when it is determined that the accessor is not sensed at the destination, the controller 126 may control the door to maintain the locked state so as to wait for the guardian within the autonomous mobility. That is, the controller 126 may control the passenger not to alight arbitrary when the guardian of the passenger is not identified at the destination.

When the accessor is identified as the guardian of the passenger, the controller 126 may determine that the guardian has arrived at the destination and guide the passenger to alight, and may unlock the door,

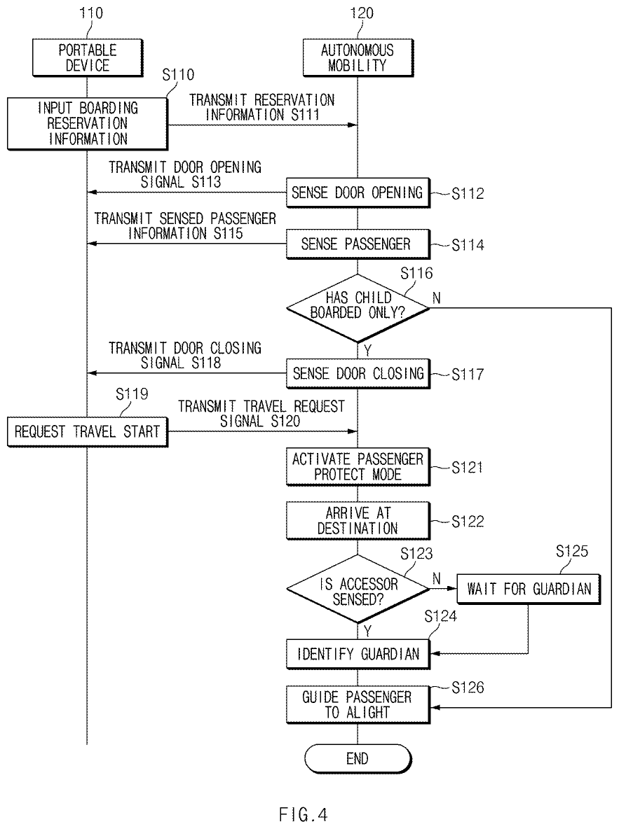

FIG. 4 is a diagram illustrating an autonomous mobility control method in some forms of the present disclosure.

As shown in FIG. 4, the portable device 110 may input the boarding reservation information (S110). In S110, the portable device 110 may perform the output through the output device 114 such that the person who makes the reservation inputs the boarding reservation information. As an example, when the passenger under the preset age is included in the boarding reservation information, the controller 115 may select the minor boarding mode, and output the guide message such that the boarding reservation information is input. In some forms of the present disclosure, the controller 115 may output the guide message such that the information on the person who made the reservation, the passenger information, the destination information, and the information on the guardian of the passenger are input as the boarding reservation information.

When the minor boarding mode is selected and the boarding reservation information is input, the portable device 110 may transmit the boarding reservation information to the autonomous mobility (S111). In addition, when the door closing signal is received after receiving the information indicating that the passenger matching the boarding reservation information (the passenger information) is sensed from the autonomous mobility, the controller 115 may transmit the travel request signal of the autonomous mobility generated by the input of the person who made the reservation.

When the reservation information is received from the portable device 110 and the door opening is sensed (S112), the autonomous mobility 120 may transmit the door opening signal to the portable device 110 (S113).

In addition, when sensing the door opening, the autonomous mobility 120 may determine that the passenger is on board and may sense the passenger (S114). In S114, the autonomous mobility 120 may sense the passenger based on one or more of the image of the passenger, the weight of the passenger, and the authentication information of the passenger using the camera 122 and the sensor 123. In addition, when the passenger is sensed, the controller 126 may transmit the sensed passenger information to the portable device 110 (S115).

The autonomous mobility 120 may determine whether the sensed passenger and the passenger information included in the boarding reservation information match with each other (S116). In some forms of the present disclosure, because the boarding reservation information received by the autonomous mobility 120 includes the information of the passenger under the preset age, the operation of determining whether the sensed passenger and the passenger information included in the boarding reservation information match with each other in S116 is preferably understood as the operation of determining whether the sensed passenger is the passenger under the preset age (e.g., the child).

When the sensed passenger and the passenger information included in the boarding reservation information match with each other (Y) in S116, that is, when it is determined that the sensed passenger is the passenger under the preset age, the autonomous mobility 120 may sense the door closing (S117). When sensing the door closing, the autonomous mobility 120 may transmit the door closing signal to the portable device 110 (S118).

On the other hand, when it is determined in S116 that the sensed passenger and the passenger information included in the boarding reservation information do not match with each other (N), that is, when it is determined that the sensed passenger is not the passenger under the preset age, the autonomous mobility 120 may control to guide the passenger to alight (S126). In some forms of the present, disclosure, in S126, the autonomous mobility 120 may unlock the door to allow the passenger to alight.

When receiving the door closing signal (S118) after receiving the information indicating that the passenger matching the boarding reservation information (the passenger information) is sensed from the autonomous mobility 120 (S115), the portable device 110 may generate the travel request signal of the autonomous mobility by the input of the person who made the reservation (S119). In addition, when the travel request signal is generated, the portable device 110 may transmit the travel request signal to the autonomous mobility 120 (S120).

When the travel request signal is received from the portable device 110 (S120) after the door closing signal is transmitted to the portable device 110 (S118), the autonomous mobility 120 may control to start the travel. The autonomous mobility 120 may allow the autonomous mobility to travel to the destination by activating the passenger protect mode while starting the travel (S121). In some forms of the present disclosure, when the passenger protect mode is activated in S121, the autonomous mobility 120 may start recording the acquired audio and image after the passenger is sensed, output the video for the child, and control to maintain the state in which the communication, with the person who made the reservation is possible. In addition, when the passenger protect mode is activated, even when there is the input of the passenger inside the autonomous mobility, the autonomous mobility 120 may determine the input as the wrong manipulation and deactivate the function based on the input of the passenger. That is, when the travel of the autonomous mobility starts, the autonomous mobility 120 may monitor the passenger in real time, and may perform the operation capable of protecting the passenger.

When it is determined that the passenger has arrived at the destination (S122), the autonomous mobility 120 may determine whether the accessor accessing the autonomous mobility is sensed at the destination (S123). In some forms of the present disclosure, in S123, the autonomous mobility 120 may determine whether the accessor is sensed based on the image of the surrounding region acquired by the camera 122.

When it is determined in S123 that the accessor is sensed at the destination (Y), the autonomous mobility 120 may compare the sensed accessor with the boarding reservation information (the information on the guardian of the passenger) to determine whether the accessor is the guardian of the passenger (S124). In some forms of the present disclosure, in S124, the autonomous mobility 120 may acquire one or more of the image of the accessor, the authentication code of the accessor, and the fingerprint, and may determine whether the sensed accessor is the guardian of the passenger included in the boarding reservation information based on the acquired information.

On the other hand, when it is determined in S123 that the accessor is not sensed at the destination (N), the autonomous mobility 120 may control the passenger to wait for the guardian within the autonomous mobility 120 (S125). As an example, in S125, the autonomous mobility 120 may control the door to maintain the locked state in S123. That is, the controller 126 may control the passenger not to alight arbitrary when the guardian of the passenger is not identified at the destination.

When the accessor is identified as the guardian of the passenger in S124, the autonomous mobility 120 may determine that the guardian has arrived at the destination and guide the passenger to alight (S126). The autonomous mobility 120 may unlock the door in S126.

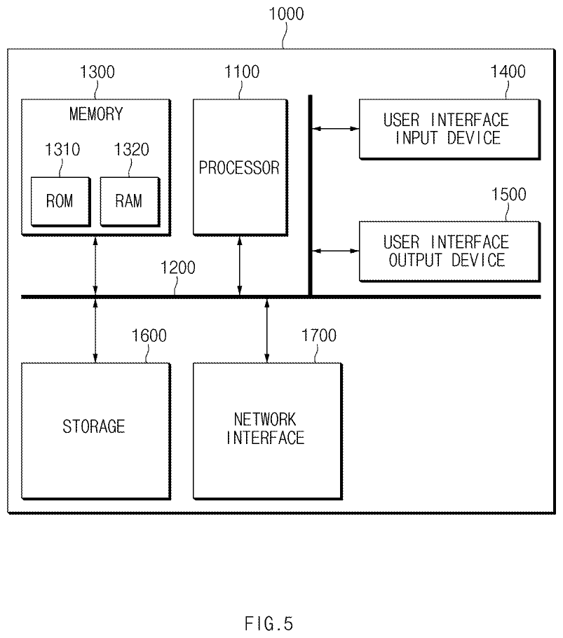

FIG. 5 illustrates a configuration of a computing system in which a method in some forms of the present disclosure is implemented.

With reference to FIG. 5, a computing system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in some forms of the present disclosure may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure, and various modifications and changes may be made by those skilled in the art without departing from the essential characteristics of the present disclosure.

Therefore, the forms disclosed in the present disclosure are not intended to limit the technical idea of the present disclosure but to illustrate the present disclosure, and the scope of the technical idea of the present disclosure is not limited by some forms of the present disclosure. The scope of the present disclosure should be construed as being covered by the scope of the appended claims, and all technical ideas falling within the scope of the claims should be construed as being included in the scope of the present disclosure.

The system and the method for controlling the autonomous mobility in some forms of the present disclosure may allow the child passenger to safely travel from a boarding point to the destination even when the child boards the autonomous mobility alone.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A system for controlling an autonomous mobility, the system comprising:
a portable device configured to input and transmit boarding reservation information of a passenger under a preset age; and
the autonomous mobility configured to:
sense the passenger;
activate a passenger protect mode and travel to a destination when the sensed passenger matches the boarding reservation information;
determine whether a guardian of the passenger has arrived at the destination after arriving at the destination; and
determine whether to allow the passenger to exit based on a determination result.

2. The system of claim 1, wherein the boarding reservation information includes at least one of information on a person who made a reservation, passenger information, destination information, or information on the guardian of the passenger.

3. The system of claim 2, wherein the portable device is configured to:
transmit a travel request signal of the autonomous mobility generated by an input of the person who made the reservation.

4. The system of claim 1, wherein the autonomous mobility is configured t.o:
sense the passenger based on at least one of an image of the passenger, a weight of the passenger, or authentication information of the passenger.

5. The system of claim 1, wherein the autonomous mobility is configured to:
guide the passenger to exit when the sensed passenger does not match the boarding reservation information.

6. The system of claim 2, wherein the autonomous mobility is configured to:
record audio and image after the passenger is sensed;
output a video for a child; and
maintain a communication with the person who made the reservation when the passenger protect mode is activated.

7. The system of claim 1, wherein the autonomous mobility is configured to:
determine whether an accessor is sensed at the destination based on surrounding environment information after arriving at the destination.

8. The system of claim 7, wherein the autonomous mobility is configured to:
acquire information including at least one of an image, an authentication code, or a fingerprint of the accessor when the accessor is sensed; and
compare the acquired information with the boarding reservation information to determine whether the accessor is the guardian of the passenger.

9. The system of claim 7, wherein the autonomous mobility is configured to:
maintain a door to a locked state when it is determined that the accessor is not sensed at the destination.

10. The system of claim 1, wherein the autonomous mobility includes a robotaxi.

11. A method for controlling an autonomous mobility, the method comprising:
inputting, by a portable device, boarding reservation information of a passenger under a preset age;
transmitting, by the portable device, the boarding reservation information to the autonomous mobility when the boarding reservation information of is input;
sensing, by the autonomous mobility, the passenger;
activating, by the autonomous mobility, a passenger protect mode and travelling to a destination when the sensed passenger matches the boarding reservation information;
determining, by the autonomous mobility, whether a guardian of the passenger has arrived at the destination after arriving at the destination; and
determining, by the autonomous mobility, whether to allow the passenger to exit based on a determination result.

12. The method of claim 11, wherein the boarding reservation information includes at least one of information on a person who made a reservation, passenger information, destination information, or information on the guardian of the passenger.

13. The method of claim 12, further comprising:
transmitting, to the autonomous mobility, a travel request signal of the autonomous mobility generated by an input of the person who made the reservation.

14. The method of claim 11, wherein sensing the passenger comprises:
sensing, by the autonomous mobility, the passenger based on at least one of an image of the passenger, a weight of the passenger, or authentication information of the passenger.

15. The method of claim 11, further comprising:
guiding the passenger to exit when the sensed passenger does not match the boarding reservation information.

16. The method of claim 12, wherein activating the passenger protect mode comprises:
recording, by the autonomous mobility, audio and image after the passenger is sensed;
outputting a video for a child; and
maintaining a communication with the person who made the reservation.

17. The method of claim 11, further comprising:
determining whether an accessor is sensed at the destination based on surrounding environment information after arriving at the destination.

18. The method of claim 17, further comprising:
acquiring information including at least one of an image, an authentication code, or a fingerprint of the accessor when the accessor is sensed; and
comparing the acquired information with the boarding reservation information to determine whether the accessor is the guardian of the passenger.

19. The method of claim 17, further comprising:
maintaining a door to a locked state when it is determined that the accessor is not sensed at the destination.

20. The method of claim 11, wherein the autonomous mobility includes a robotaxi.
